(19) United States
(12) Patent Application Publication
(10) Pub. No.: US 2001/0025234 A1
(43) Pub. Date: Sep. 27, 2001

(54) Method for simulating and/or designing a bearing rail component

(75) Inventors: Ulrich Becker, Detmold (DE); Dirk Menke, Beverungen (DE)

Correspondence Address: Lawrence E. Laubscher, Sr., 745 South 23rd Street, Arlington, VA, 22202-2451, US

(73) Assignee: Weidmuller Interface GmbH & Co., Detmold (DE)

(21) Appl. No.: 09/802,875

(22) Filed: Mar. 12, 2001

(30) Foreign Application Priority Data
Mar. 16, 2000 (DE) 100 12 771.8

(51) Int. Cl. G06G 7/54; G06F 17/50

(52) U.S. Cl. 703/18; 703/13

(57) ABSTRACT

A method is disclosed including a software routine for simulating and designing an electrical power distribution system, wherein the assembly of terminal blocks or modules is displayed on a computer screen as being mounted on a mounting rail. More particularly, instead of being illustrated graphically, the terminal blocks and modules are displayed in the form of a data structure constructed from a plurality of virtual token elements mounted on a support rail.

### SPECIFICATION

1. Field of the Invention

A computerized method is disclosed including a software routine for producing on a computer screen a simulated replica of an electrical distribution system including an assembly of electrical terminal and/or module components mounted on a common mounting rail.

### BACKGROUND OF THE INVENTION

2. Brief Description of the Prior Art

It is well known in the electrical power distribution art to supply electrical power to office buildings, hotels, hospitals, apartments, and the like via an assembly of a plurality of terminal blocks and/or components mounted on a support rail contained in an electrical panel box. Examples of such electrical power distribution systems are disclosed in the prior U.S. Pat. Nos. to Frikkee, et al., 5,318,461 and Glathe, et al., 5,722,862, among others.

Known processes for the photorealistic illustration of mounting rail in-line assemblies which employ, during the planning phase, a list of suitable components and which, after the termination of the planning phase, generate a graphic display from the component availability lists. During the designing and planning phase, therefore, one cannot work with or edit the graphic display. Only symbols in the component availability list provide any hint as to the article that is used.

Most existing systems therefore are relatively awkward and do not sufficiently simplify the planning phase; their structure is not sufficiently variable. It is therefore the object of the present invention to simplify the illustration of mounting rail in-line assembly on the screen.

### SUMMARY OF THE INVENTION

Accordingly, a primary object of the present invention is to provide an improved method for designing a rail-mounted component assembly for an electrical power distribution system, wherein a software routine is utilized to simulate the in-line assembly on a computer screen, with the individual junction blocks or terminals being depicted directly as the image of a data structure consisting of individual token elements mounted on a support rail.

According to a more specific object of the invention, the individual terminal blocks and/or other elements and/or other equipment are not illustrated as a real graphic, but rather, directly as the illustration as a data structure made up of individual token elements on the mounting rail. The essential advantage deriving from this design consists of the following: The elements of the screen display become intelligent in an “object-oriented” manner, and one creates a more flexible system that is not rigid, which definitely simplifies the planning of mounting in-line assembly, because, during the planning phase likewise, the ability to edit is also ensured in the graphic mounting rail simulation. The basic principle therefore corresponds more closely to the actual assembly of the terminal block components on the mounting rail.

According to another object of the invention, the terminal blocks and/or other elements and/or other equipment are illustrated on the screen in a photorealistic manner. In the process, the individual clamp elements are stored in a databank and, during simulation of the locking of the terminal block on the mounting rail. Preferably, a memory area is reserved in a memory for a product to be illustrated, whereupon, necessary information will be read out of a databank, will be interpreted, and will be displayed as the smallest possible graphic element on the screen, with each individual element representing one of the tokens. In the process, each token is preferably allocated changeable properties.

### BRIEF DESCRIPTION OF THE DRAWINGS

Other objects and advantages of the invention will become apparent from a study of the following specification.

When viewed in the light of the accompanying drawings, in which:

FIG. 1 illustrates a display screen that is used with the simulation and design system of the present invention;

FIG. 2 illustrates a component selective menu according to the present invention;

FIG. 3 illustrates a component library, according to the present invention; and

FIG. 4 is token data chart used in selecting a given terminal block for the electrical distribution system.

### DETAILED DESCRIPTION

During the design and manufacture of an electrical distribution system, consideration must be given to the planning phase wherein the scope of a project is broadly defined; the construction phase, wherein the data of the plan is converted to a CAD/CAS system or to paper; the finalization phase, wherein the plan is reduced to actual practice; and the implementation phase, wherein the system is used in commerce.

Data are repeatedly exchanged, altered, or past on between the individual phases of a project. The type of data transmission here varies greatly. Fax and telephone are primary information transmitting media. These transmission media however, are relatively awkward because, when a fax arrives, a renewed data pickup is necessary, although the data possibly are already present at the customer-end in data form. Besides, there can easily be transmission errors in the case of fax or phone transmission. When parts of the project, for example, are handled with outside partners, it is a matter of the utmost importance that the details be transmitted absolutely clearly. Errors in transmission are fatal. They result in an increased effort devoted to the clarification of the situation during the economic feasibility phase. This therefore unnecessarily delays the submission of the actual offer.

The following example describes the procedural steps for the production of a terminal strip, needed in the project, with an outside partner.

Development Example I

(a) The customer acquires the individual terminal strips with the help of a catalog

(b) Transmission of terminal strip data via fax or mail

(c) Acquisition and evaluation of transmitted data and checking by telephone with the final customer

(d) Manual input of data into the existing commodity management system

(e) Calculation of terminal strips and their mounting

(f) Determination of a sales price

(g) Submission of offer

(h) Customer confirms order

(i) Production of terminal strips on the basis of the transmitted fax data

A considerable improvement in the work flow can be achieved by using intelligent software products and employing new technical possibilities (E-mail, FTP, Web-Browser). This results in the following advantages:

(a) No-loss transmission or relaying of project data file

(b) Possibility of subsequently processing the project data files

(c) Time savings in all phases of project processing at the end of the client or the contractor until the terminal strip is finished

(d) Independent of sites and localities

(e) Minimizing error sources

The development shown in Example 1 demands a very large effort in terms of personnel. Due to the constant telephone inquiries until the complete clarification of the order, the preparation and submission of an offer can take up several days or weeks. On the other hand, one gets the preferred following development when one uses the system according to the present invention, wherein:

(a) The project data file is put together at the start of the project and is forwarded from phase to phase

(b) The planner and the designer prepare the necessary flow chart

(c) The data are imported by the designer into the Rail-Designer

(d) Transmission of terminal strip data directly by e-mail

(e) Automated data acquisition in commodity management system

(f) Automatic calculation of terminal strips and their mounting

(g) Determination of a sales price and automatic submission of offer

(h) Assembly of terminal strip with support of software at workstation

The main problem involved in the invention-based process (also called Rail-Designer) is the optimization of the work flow during project preparation, ordering and assembly of terminal strips by electronic means. With regard to operability, utmost emphasis was placed on the original illustration of the real and the virtual world.

The present invention provides an interactive project preparation and ordering program for terminal strips (Offline e-commerce System). One particular feature of the invention relates to the way in which a terminal strip can be in-line assembled in a virtual manner.

Practical conditions are depicted in the program at all times. The terminals are taken from a “box” and are locked upon top of the mounting rail. This is followed by working on the terminals and their connections. Once the entire project has been completed, the inquiry or the order is put in electronically via the click of a mouse. The individual terminals are not inserted as a graphic upon the terminal strip; instead, they are depicted directly from the data structure. This procedure is referred to, in-house, with the concept of “Database Painting.” This now makes it possible to convert the otherwise “quiet” pictures into living objects. The in-line assembly of the terminal with a marking is now facilitated just as the plug-in of a cross-connection. Each object detail can at any time be displayed for the user, for example, cross-connection, marking, screw, attachment, and the like. The terminals are viewed in a photorealistic manner. In order better to support the selection, a digital photo and the expanded data are added to each article via logical tie-ins.

A terminal is constructed in specific terms according to the following principle. The individual terminal details are acquired in the virtual world as so-called tokens and are deposited in a databank. A token is basically a separate partial object with its own properties. If the user now assembles the terminal strips in-line with a terminal, then the token information items are read out of the databank. With these values, the terminal is now constructed piece by piece, from bottom to top. It is positioned, and provided with the corresponding properties. This creates the impression of a picture on the monitor, but appearances are deceptive. A terminal consists of many small objects that, by themselves, have their own properties, such as, for example, an article color.

There are two main aspects that make the work easier—namely, the speed and the game-like operating control. The time needed to learn the program is confined to a minimum because the Windows-Notation is followed throughout.

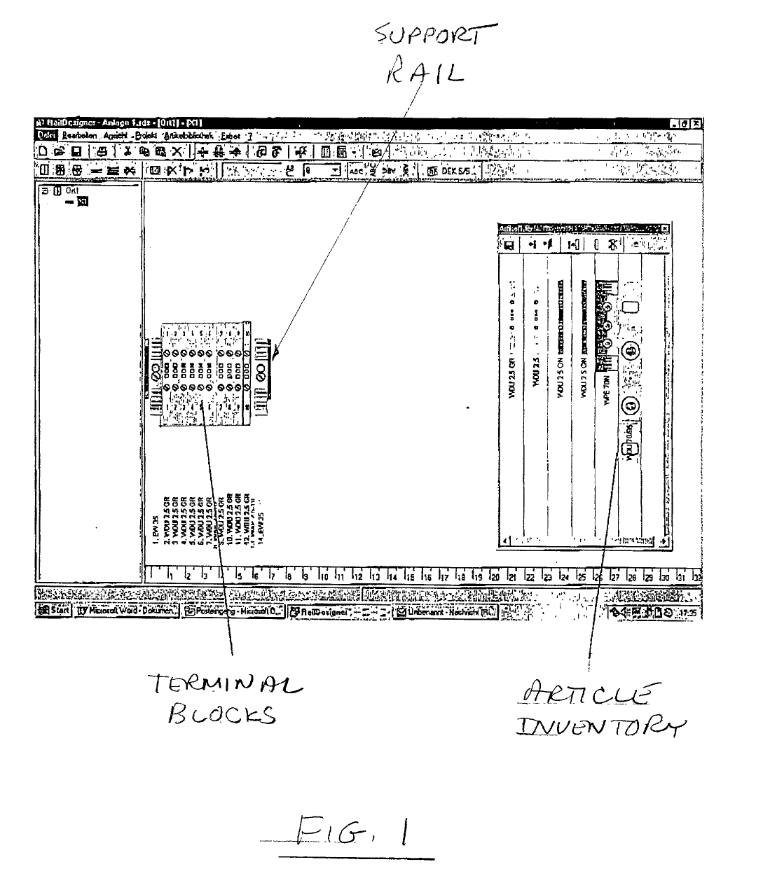

The operation of the invention will be explained in greater detail. According to the invention, the products—such as, for instance, a terminal block—are illustrated graphically in several steps. First of all, one reserves the necessary memory space for the project to be illustrated. This is followed by the detailed construction of the partial elements in this framework, from top to bottom. For this purpose, one reads the necessary information items out of a databank. Then, these information items are interpreted and are displayed on the screen as the smallest possible graphic element, as shown in FIG. 1. These individual graphic elements are referred to below as tokens. The number of necessary tokens to illustrate a product depends on the complexity of the product. The type, size, and appearance of a token; that is, the properties of the element can be modified as desired by various methods. The sum of all tokens forms the complete illustration of the product on the screen. Every token can take on any shape; it is therefore possible to illustrate any products on the screen and to provide them with active functional qualities. All tokens have properties that can be changed by means of corresponding methods. This might be explained in greater detail with the aid of an illustrative example.

More particularly, in order to provide an illustration area, the moderator selects a bulletin pin-board. In his demonstration case are contained a plurality of cardboard pieces having varying geometries and identical colors. The moderator would like to illustrate a washing machine, for example, with the cardboards on the pin-board. For this purpose, he looks at his construction plan (which corresponds to the databank) and, from the case, takes a corresponding cardboard piece. The positions, color, and other necessary properties are now allocated to the cardboard piece; that is, the cardboard piece is painted on, cut out, written on, etc. The moderator repeats this procedure until all elements, necessary for visual display, have been stuck on the bulletin board. To change the visual display, one removes the cardboard piece and substitutes another piece provided, for example, with changed text. In this way, one can also change individual elements in a washing machine whose illustration has already been finished.

The above-illustrated procedure is analogous to the procedure involved in the graphic illustration of the products on the screen in the context of the present invention. The tokens basically correspond to the cardboard pieces. The type, size, and appearance of the token; that is, the properties of the element can be modified as desired by different methods. The sum of the tokens forms the illustration of the product (for example, terminal block) on the screen. An example here can be found in FIG. 4. This is a simplified illustration of a terminal block with its tokens and their properties.

On the other hand, looking at the state of the art, to illustrate a product on the screen, one usually employs a picture format, for example, the TIF, BMP, CDR, WMF or DXF format. These data file formats differ essentially by virtue of the type and size of the stored picture information. A picture in these formats is stored in dot-by-dot form or as vector. If one looks at each dot of the picture in one of these formats, one finds that the individual dots do not have any intelligence. Existing programs use, as static pictures over tables, small symbols for visual display.

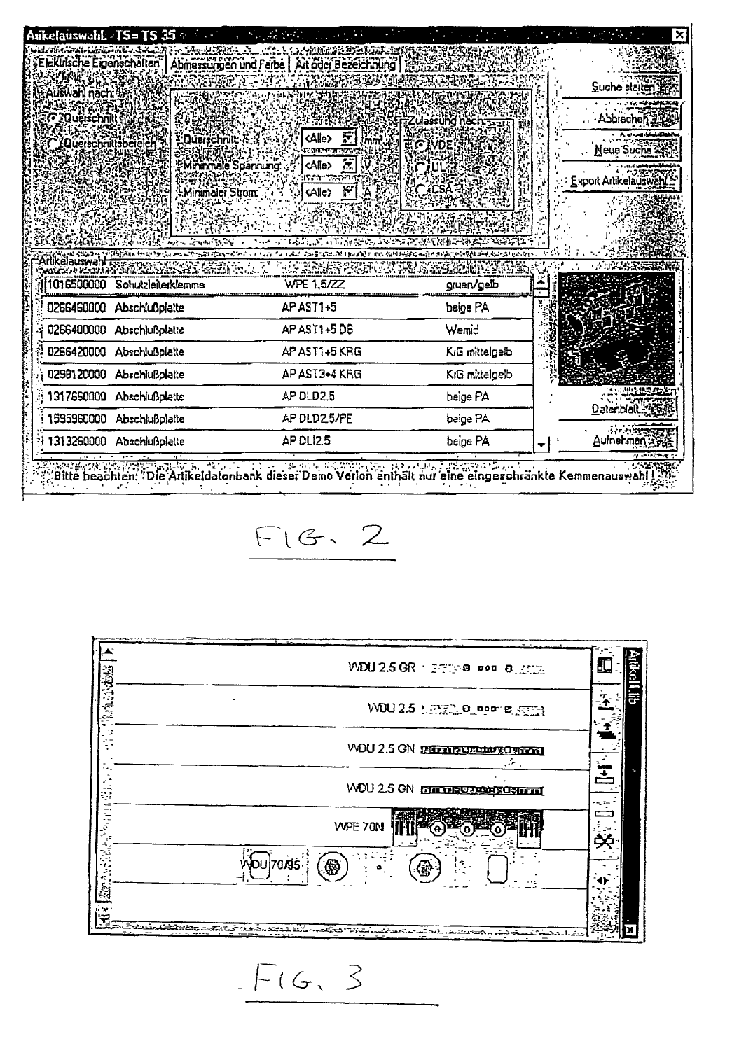

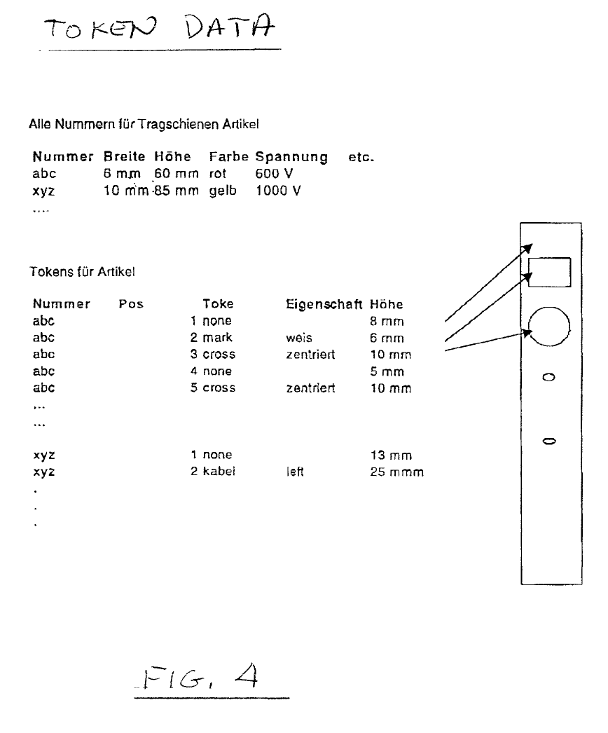

On the other hand, the main advantage inherent in the system of the present invention is that it can be put together with the graphic data which therefore can be processed in a particularly fast manner. Furthermore, it is possible to adapt the properties of a product to individual needs. There is no need for any further programming to illustrate new surfaces. Merely by supplementing the databank with new articles and the pertinent documents, one can now visually display new designs (see FIGS. 1 and 2). FIG. 2 shows an article selection window. By specifically putting in search criteria, one can, by means of this search window, find the desired article and it can be included in the table of the article library for further processing of the project. This procedure entails the advantage that the illustration of various products can take place quickly and realistically on the screen. It is furthermore also possible to modify a product, whose illustration has been finished, on the screen, via the user surface. Each product, even in detail, has an intelligence of its own that is represented by the token. The memory requirement, compared to the picture formats of the kind mentioned above, is very small; this has yet another advantageous effect as regards the processing speed. As an example for an intelligence bearing token, one might refer to FIG. 4. In the upper example, the token is illustrated, whereas, in the lower example, the token is provided with a marker with any desired text information to illustrate the terminal block.

In conventional realization with static pictures, such as, for example, in the BMP format, all possible text entries must be readily accessible as image data file. The number of various possibilities accordingly is very great. It is not realistic to store all combinations.

When tokens are used, on the other hand, the marker token is merely informed that the color and text content must be changed. It is thus easily and without any problems possible to put in and immediately display any text information. The reverse is also possible. The token can, in the user program, at any time, communicate its current properties. In cross-product functions, for example, when putting in cross connections, the X, Y, and Z positions of a token, can be used, for instance, for a functional check.

While in accordance with the provisions of the Patent Statutes the preferred form and embodiment of the invention have been illustrated and described, it will be apparent to those skilled in the art that various changes may be made without deviating from the inventive concepts set forth above.

What is claimed is:

1. A method for simulating and designing an electrical power distribution system with a software routine, comprising:
(a) providing a computer display screen; and
(b) displaying on said screen a visual image of individual terminal blocks and electrical modules in the form of tokens mounted on a mounting rail.

2. A method as defined in claim 1, wherein the terminal blocks and electrical modules are displayed in a photorealistic manner.

3. A method as defined in claim 1, wherein an inventory of the individual terminal blocks is stored in a data storage bank; and further wherein during the simulation of the mounting of a terminal block token on the mounting rail, the removal of the terminal blocks from the inventory in the data storage bank is successively read out and displayed on the computer screen.

4. A method as defined in claim 3, wherein the data storage bank contains a memory space that is reserved for the terminal block to be illustrated; and further wherein the items removed from the inventory are read out of the data bank, interpreted, and displayed as the smallest possible graphic element on the screen, and wherein each element from the inventory corresponds with one of the tokens.

5. A method as defined in claim 1, wherein the physical properties represented by the tokens are variable.
